(19) United States
(12) Patent Application Publication
(10) Pub. No.: US 2014/0195038 A1
(43) Pub. Date: Jul. 10, 2014

(54) DIE-CUTTING MACHINE AND METHOD FOR ADJUSTING A PRESSING FORCE IN A DIE-CUTTING MACHINE

(71) Applicant: HEIDELBERGER DRUCKMASCHINEN AG, Heidelberg (DE)

(72) Inventors: STEPHAN BALLEIS, HEIDELBERG (DE); ANDREAS DETMERS, HEDDESHEIM (DE); DAVID EHRBAR, WALLDORF (DE); HOLGER LEONHARDT, MECKESHEIM (DE); MARKUS MOEHRINGER, WEINHEIM (DE); PETER PALMEN, MOENCHENGLADBACH (DE); RAFAEL PISARSKI, NUSSLOCH (DE); ANNA WYSGOL, WALLDORF (DE)

(73) Assignee: HEIDELBERGER DRUCKMASCHINEN AG, Heidelberg (DE)

(21) Appl. No.: 14/152,039

(22) Filed: Jan. 10, 2014

(30) Foreign Application Priority Data
Jan. 10, 2013 (DE) 102013000299.0

(51) Int. Cl. B30B 12/00

(52) U.S. Cl. CPC B30B 12/00
USPC 700/206

(57) ABSTRACT

A method for adjusting a pressing force of a flat-bed die-cutting and/or stamping/embossing machine having at least one die-cutting and/or embossing/stamping tool for processing a flat printing substrate, includes supplying tool data describing an individual structure of a die-cutting and/or stamping/embossing tool of a plurality of tool parts, reading specific force data out of a database, the specific force data assigning a specific pressing force to a respective tool part, calculating a target pressing force at least from the tool data and the specific force data adjusting the pressing force of the flat-bed die-cutting and/or stamping/embossing machine to the target pressing force. The adjustment of the pressing force is advantageously simplified to a considerable extent and reduces the error-proneness and the time required for setting up the flat-bed die-cutting and/or stamping/embossing machine. A machine for implementing the method is also provided.

### CROSS-REFERENCE TO RELATED APPLICATION

This application claims the priority, under 35 U.S.C. §119, of German Patent Application DE 10 2013 000 299.0, filed Jan. 10, 2013; the prior application is herewith incorporated by reference in its entirety.

### BACKGROUND OF THE INVENTION

### Field of the Invention

The invention relates to a method for adjusting a pressing force in a flat-bed die-cutting and/or stamping/embossing machine having at least one die-cutting and/or embossing/stamping tool for processing a flat printing substrate. The invention also relates to a flat-bed die-cutting and/or stamping/embossing machine for implementing the method.

Die-cutting refers to the process of cutting with closed geometric cutting shapes, which may be circular, oval, polygonal, or any desired shape. Processes such as stamping with hollow punches, corner trimming, and index cutting, which are common in the further processing of printed products, may also be counted among the die-cutting processes. The cutting process is carried out against a cutting pad or against dies. In some cases, it may be a shearing process. What is cut is mainly sheet-shaped, but also web-shaped packaging substrates made of plastic, foil substrate, paper, board, cardboard, or corrugated board. A die-cutting process may additionally create crease lines or blind embossments in the blank. Since the final products are packages that are highly sophisticated in terms of their technical and graphic features (special packages for cosmetics, cigarettes, pharmaceuticals, food etc.), for optimum results, the substrates themselves must meet special requirements, the die-cutting tools must operate within narrow tolerances, and the die-cutting machine needs to function with a high degree of accuracy and reliability. The process that best meets those requirements is flat-bed die-cutting. If the substrate to be processed is sheet-shaped, printed sheets that are stacked on a pallet are fed to the die-cutting machine. In the machine, the sheets to be cut are accurately aligned in an alignment device. Then the sheets are transferred to a gripper carriage, which positions them accurately in the die-cutting device between a stationary lower table and an upper table that is vertically movable by a toggle lever or eccentric gear. In some machines, the upper table is stationary and the lower table is movable.

In known sheet-fed die-cutting and/or stamping/embossing machines for die-cutting, stamping/embossing, stripping, potentially blanking, and depositing sheets of paper, board or the like, it is known to use gripper carriages for transporting the sheets through the individual units of the machine. A respective gripper carriage includes a gripper bar carrying grippers that grip a leading end of a sheet. A gripper carriage further includes lateral carriages that are connected to endless chains of the transport system to transport the gripper carriages through the machine. That manner of moving the sheets through the machine allows a high machine throughput since the sheets are processed successively in the individual units of the machine that are disposed in-line, in particular the cutting, stripping, and blanking units.

A flat-bed die-cutting machine of that type is known, for example, from German Patent Application DE 30 44 083 A1, corresponding to U.S. Pat. Nos. 4,903,560, 4,763,551 and 4,485,708, and from U.S. Pat. No. 7,658,378 B2. The two tables are equipped with cutting and creasing tools and suitable countertools. The tools are used to cut blanks out of the sheets that are cyclically moved between the table surfaces and simultaneously to form the crease lines required for clean folds. In the following stripping device, the waste is automatically removed by stripping tools. Depending on the equipment of the machine, the cut blanks may be separated in a blanking unit provided for that purpose.

In order to obtain high-quality products, the pressing force in the sheet-fed die-cutting and/or stamping/embossing machine needs to be adaptable to the sheets to be processed. As described in German Patent DE 30 44 083 C3, corresponding to U.S. Pat. Nos. 4,903,560, 4,763,351 and 4,485,708, that is done by displacing wedge-shaped steel plates. Those steel plates are located between eccentric shafts and the driven upper table. The displacement of the wedge-shaped steel plates modifies the distance between the movable upper table and the stationary lower table and thus the cutting force.

In order to attain sufficient pressing force on one hand while reliably avoiding the application of too much pressure and thus damage to the cutting tools on the other hand, the operator needs to find the optimum pressing force in a slow and careful approach. When combined with manual backing alignment of the die-cutting tool, that results in a very time-consuming set-up process.

### SUMMARY OF THE INVENTION

It is accordingly an object of the invention to provide a die-cutting machine and a method for adjusting a pressing force in a flat-bed die-cutting and/or stamping/embossing machine, which overcome the hereinafore-mentioned disadvantages of the heretofore-known methods and machines of this general type and which allow a considerably simplified adjustment of the pressing force, which reduces the amount of errors and the time required for setting up the flat-bed die-cutting and/or stamping/embossing.

With the foregoing and other objects in view there is provided, in accordance with the invention, a method for adjusting a pressing force of a flat-bed die-cutting and/or stamping/embossing machine, which includes a die-cutting and/or stamping/embossing tool for processing a flat printing substrate. The invention comprises providing job-dependent tool data in an initial step. The tool data describe the specific structure of a die-cutting and/or stamping/embossing tool from a plurality of tool parts. Subsequently, specific pressure data stored in a database are read out of the database. The specific pressure data allocate a specific pressing force to each respective tool part. Then a calculation of a desired pressing force is made based on the tool data and the specific pressure data. The pressing force of the flat-bed die-cutting and/or stamping/embossing machine is set to the calculated target pressing force by a corresponding actuation of an adjustment device. An advantage of this process is that the operator does not have to use a slow and careful approach to find the required die-cutting force for obtaining a good die-cut. Instead, he or she can start the first die-cutting process with a pressing force that is close to the optimum pressing force. This implies a considerable acceleration of the machine set-up in the case of a job change, which means that production according to quality requirements may start sooner and the number of waste sheets created during set-up may be reduced.

In accordance with another mode of the method of the invention, in an additional step, the effective pressing force may be corrected by the operator after a first die-cutting or pressing process and after an examination of a cut or stamped/embossed printing substrate. The machine control of the flat-bed die-cutting and/or stamping/embossing device may suggest correcting steps. In accordance with a particularly advantageous feature, the pressing force may be stored for repeat jobs to even further reduce the set-up time required for repeat jobs.

In accordance with a particularly advantageous and thus preferred further development of the method of the invention, the tool data include information on the type of each tool part and on the effective length and/or area of each tool part. Among the tool parts, a distinction may be made between cutting knives, creasing knives, rubber elements, embossing dies, etc. A more detailed distinction is preferred, for example between different cutting knives having different geometric cutting shapes, between different creasing knives having different geometric creasing shapes, and between different rubber elements of different width and elasticity. Where embossing dies are concerned, a distinction may be made between different die substrates and embossing depths. In addition to information on the type of the tool part, the tool data contain information on the effective length of the respective tool part if it is a cutting knife, a creasing knife, or a rubber element, or on the effective area if it is an embossing die. In accordance with an advantageous aspect, the specific force data in the database are given as a required pressing force per effective length or effective area of a respective tool part, i.e. different specific cutting forces, creasing forces, rubber element forces, and embossing forces are stored in the database. A required target pressing force for the entire tool may thus be calculated by adding the individual required target pressing forces for each tool part, which have been calculated as the length or effective area of the tool part times the respective associated specific pressing force. In accordance with a particularly advantageous further development of the method of the invention, the specific force data are a function of the printing substrate to be processed, for example of its thickness, its substrate composition, and its format. The specific force data stored in the database are to be determined in advance in extensive test series in a special individual measurement test rig. Thus these data are provided by the manufacturer of the machine. The more exhaustive the database, i.e. the more tool parts for different printing substrates it contains, the more accurate the calculation of the required and acceptable target pressing force in accordance with the method of the invention.

In accordance with a particularly preferred aspect, a safety, distribution, number and/or size factor may additionally be used in the calculation. In this context, a safety factor refers to a safety factor of 0.8, for example, by which the pressing force calculated from the tool data and the specific force data is multiplied. This allows the machine operator to carefully approach the actual required and acceptable pressing force from this reduced calculated pressing force while minimizing the risk of damage to the die-cutting and/or stamping/embossing tools due to pressing force settings that are too high. A distribution factor may factor in the distribution of the blanks on the entire area of the printing substrate, for example in terms of whether the blanks are evenly distributed or not. The number factor may factor in the number of blanks on a printing substrate. The size factor may in turn reflect the size of the printing substrate and/or of the die-cutting and/or stamping/embossing tool.

If no distribution factor is applied, it is alternatively possible to calculate different target pressing forces for different tool regions. In accordance with the prior art, the adjustment device for adapting the die-cutting force includes four adjustment wedges, which are adjustable independently of each other. An individual adjustment movement may be defined for each wedge in accordance with the target pressing force calculated for the specific region (i.e. quadrant).

With the objects of the invention in view, there is concomitantly provided a flat-bed die-cutting and/or stamping/embossing machine, comprising a machine control unit for implementing the method described above and a workflow connection and/or interface for receiving prepress data about the printing substrates to be processed and/or from the die-cutting/stamping/embossing tool manufacturer. The latter data may be used for the method of the invention directly as tool data or may be processed by a computer and/or an interface for inputting tool data.

Other features which are considered as characteristic for the invention are set forth in the appended claims, noting that any combination of the invention described above and of the further developments of the invention described above also represents an advantageous further development of the invention. Further advantages and embodiments of the invention that are advantageous in structural and functional terms become apparent from the dependent claims and from the description of exemplary embodiments with reference to the appended figures.

Although the invention is illustrated and described herein as embodied in a die-cutting machine and a method for adjusting a pressing force in a die-cutting machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a sheet-fed die-cutting/stamping/embossing machine; and

FIG. 2 is a roughly-diagrammatic plan view of an example of a die-cutting and/or stamping/embossing tool.

### DETAILED DESCRIPTION OF THE INVENTION

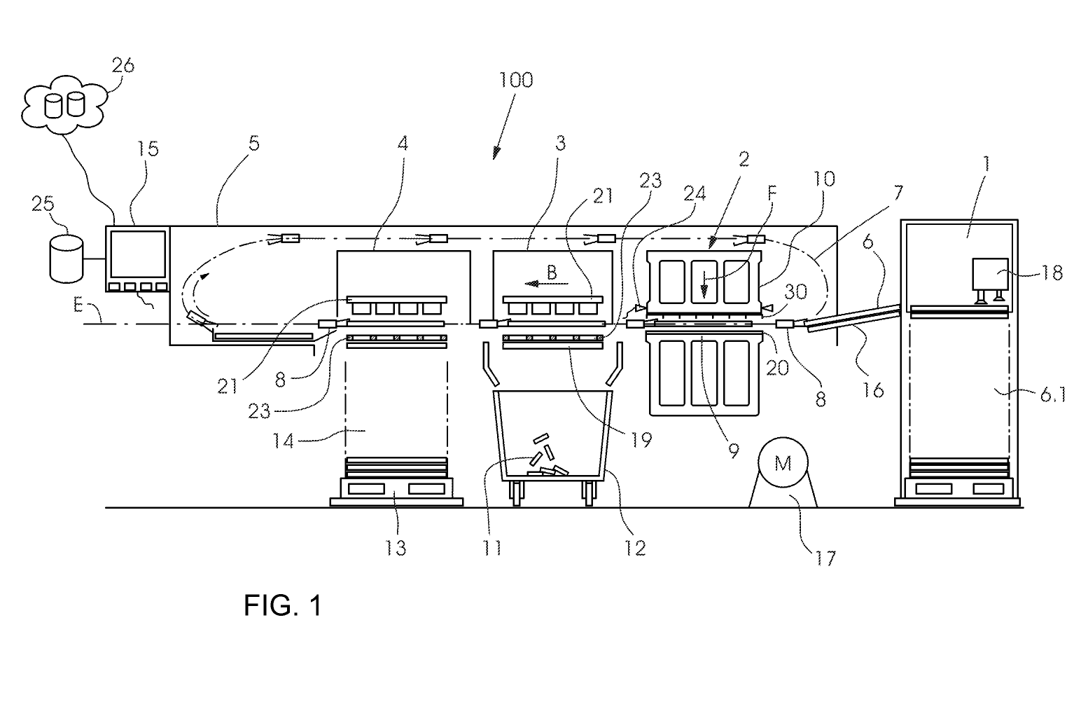

Referring now in detail to the figures of the drawings, which are not drawn to scale and in which identical reference symbols indicate corresponding elements and components, and first, particularly, to FIG. 1 thereof, there is seen a basic structure of a sheet-fed die-cutting and stamping/embossing machine 100 for die-cutting, stripping, blanking and depositing sheets made of paper, board, plastic and the like. The die-cutting and stamping/embossing machine 100 includes a feeder 1, a die-cutting unit 2, a stripping unit 3 and a delivery 4 including a depositing and blanking unit. The individual units are supported on and surrounded by a common machine frame 5 and are driven by a main drive 17. The processing units 2, 3, 4 are accessible from one side, which is referred to as the operator side. A drive train of the sheet-fed die-cutting and stamping/embossing machine 100 is located on the opposite side, which is referred to as the drive side. A machine control unit or controller 15 controls the processes within the die-cutting machine 100. The machine control unit 15 is connected to a database 25 which contains specific force data and in which settings for repeat jobs may be stored. The machine control unit 15 is further provided with an interface for inputting data, a standard interface, and a workflow connection 26 so that tool data may be supplied. The machine control unit 15 is also connected to and capable of actuating a device 24 for adjusting the pressing force by a connection for the exchange of data and is capable of actuating the device 24 for adjusting the pressing force.

Sheets 6 are taken off a stack 6.1 in the feeder 1 by a so-called suction head 18 and are transferred to a sheet transport system 7. Grippers attached to gripper bars of a gripper carriage 8 grip the leading edge of a sheet and intermittently pull the sheets in a sheet transport direction B through the various units 2, 3, and 4 of the die-cutting and stamping/embossing machine 100.

The sheet transport system 7 includes multiple gripper carriages 8 so that multiple sheets 6 may simultaneously be processed in the various units 2, 3, and 4. The gripper carriages 8 may be driven by a chain drive.

The die-cutting unit 2 is formed of a lower platen or lower table 9 and an upper platen or upper table 10. The upper table 10 is supported to be movable back and forth in a vertical direction and is equipped with an upper tool 30 that has die-cutting and creasing knives. The upper table 10 is engaged with the lower table 9 under a pressing force F. The pressing force adjustment device 24 is disposed in a mount of the upper table 10. The lower table 9 is supported in the machine frame 5 to be stationary and is equipped with a counterplate 20 corresponding to the die-cutting and creasing knives. Alternatively, the upper table 10 may be stationary and the lower table 9 may be movable. In an embossing or stamping process, embossing or stamping tools, in particular in the form of so-called embossing dies 34, are used as an alternative or in addition to die-cutting and creasing tools 31, 32.

The gripper carriage 8 transports the sheet 6 from the die-cutting and embossing/stamping unit 2 into the downstream stripping unit 3, which is equipped with stripping tools 21, 23. In the stripping unit 3, the stripping tools 21, 23 push superfluous pieces of waste 11 downward out of the sheet 6 so that they drop into a carriage-type container 12 or are removed from there.

Once it has exited the stripping unit 3, the sheet 6 enters the delivery 4, where it may be simply deposited or where individual blanks of a respective sheet 6 may be separated. For this purpose, the delivery 4 includes a blanking tool 21, 23. The delivery 4 may further include a pallet 13, on which the individual sheets 6 or blanks are stacked in a stack 14. When the sheet stack 14 has reached a certain height, the pallet 13 supporting the stack 14 may be moved out of the region of the die-cutting and stamping/embossing machine 100. Auxiliary stacking devices may be used to avoid having to stop the machine 100 during a stack change.

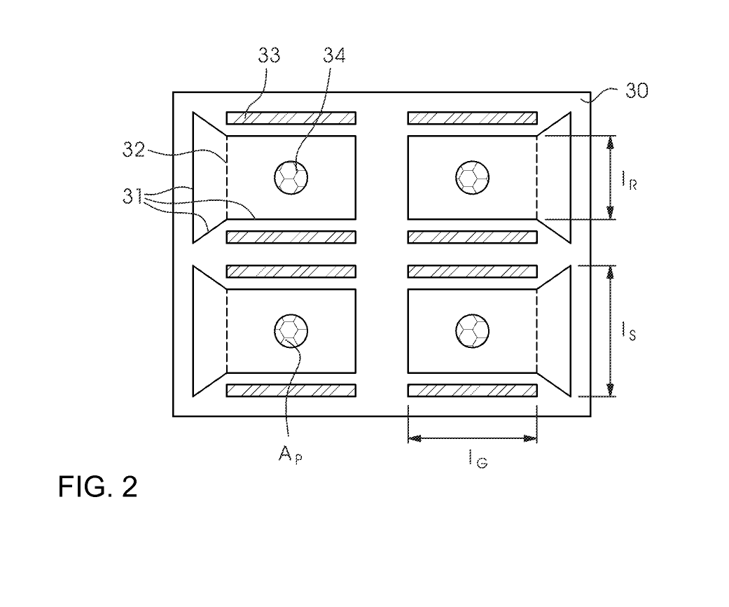

FIG. 2 illustrates a die-cutting tool 30 for processing four blanks. For this purpose, the die-cutting tool 30 includes a plurality of different tool parts such as cutting knives 31, creasing knives 32, rubber elements 33 disposed in parallel with the cutting knives 31 and a respective central circular embossing die 34. The tool data that describe this die-cutting tool 30 include the types of the respective tool parts 31, 32, 33, 34 and their effective lengths l_{S}, l_{R}, l_{G} or effective area A_{P}. Thus, the length l_{S} of the cutting knife is composed of all partial lengths of the cutting knives 31. The effective length l_{R} of the creasing knives is composed of all partial lengths of the creasing knives 32. The length l_{G} of the rubber element is composed of all partial lengths of the rubber elements 33. The effective surface A_{P} of the embossing dies in turn corresponds to the total of the surface parts of the embossing dies 34. For reasons of clarity, only one partial length or partial area is indicated by a reference symbol in FIG. 2.

If these tool data are known from a prepress stage or from the manufacturing of the die-cutting tool 30, they may be directly used to calculate a target pressing force. If these data are not available, the tool data need to be input into the machine control unit 15 using an interface.

The machine control unit 15 accesses the database 25 in which specific force data are stored for the calculation of the target pressing force F. The database 25 contains the required cutting force per meter for a specific cutting knife 31, the creasing force per meter for a specific creasing knife 32, the required force per meter for a rubber element 33 and the required embossing force per square meter for a specific embossing die 34. These specific values are multiplied by the corresponding length of the tool part (cutting length, creasing length, rubber length) or area (embossing area), and the required pressing force F is calculated by adding up the values for the tool parts 31, 32, 33, 34. The machine control unit may additionally contain multiplying factors such as a safety factor, a distribution factor, a number factor, and/or a size factor to be able to adapt the calculated pressing force before the latter is applied by the machine control unit 15 in a corresponding actuation of the adjustment device 24.

1. A method for adjusting a pressing force of a flat-bed machine for at least one of die-cutting, stamping or embossing having at least one tool for at least one of die-cutting, embossing or stamping to process a flat printing substrate, the method comprising the following steps:
a) supplying tool data describing an individual structure of a tool, of a plurality of tool parts, for at least one of die-cutting, stamping or embossing;
b) reading specific force data out of a database, the specific force data allocating a specific pressing force to a respective tool part;
c) calculating a target pressing force at least from the tool data of step a) and the specific force data of step b); and
d) adjusting the pressing force of the flat-bed machine for at least one of die-cutting, stamping or embossing to a target pressing force in accordance with step c).

2. The method for adjusting a pressing force according to claim 1, which further comprises correcting the pressing force after a first die-cutting or embossing process by operator intervention, in an additional step e).

3. The method for adjusting a pressing force according to claim 2, which further comprises storing the pressing force for repeat jobs, in an additional step f).

4. The method for adjusting a pressing force according to claim 1, which further comprises including in the tool data information on a type of a respective tool part and on at least one of an effective length or an effective area of a respective tool part.

5. The method for adjusting a pressing force according to claim 4, which further comprises indicating, with the specific force data, a required pressing force per effective length or effective area of a respective tool part.

6. The method for adjusting a pressing force according to claim 5, which further comprises providing the specific force data as a function of the printing substrate to be processed.

7. The method for adjusting a pressing force according to claim 1, which further comprises additionally using at least one of a safety, distribution, number or size factor in step c).

8. A flat-bed machine for at least one of die-cutting, stamping or embossing, the flat-bed machine comprising:
a machine controller configured to carry out the following steps:
a) supplying tool data describing an individual structure of a tool, of a plurality of tool parts, for at least one of die-cutting, stamping or embossing,
b) reading specific force data out of a database, the specific force data allocating a specific pressing force to a respective tool part,
c) calculating a target pressing force at least from the tool data of step a) and the specific force data of step b), and
d) adjusting the pressing force of the flat-bed machine for at least one of die-cutting, stamping or embossing to a target pressing force in accordance with step c), and
at least one of a workflow connection or an interface configured to receive data from at least one of a prepress stage pertaining to printing substrates to be processed or a manufacturer of the tool for at least one of die-cutting, stamping or embossing or an interface for inputting tool data.
